(19) United States
(12) Patent Application Publication
(10) Pub. No.: US 2016/0064107 A1
(43) Pub. Date: Mar. 3, 2016

(54) NUCLEAR POWER GENERATION SYSTEM

(71) Applicant: Young Sun KIM, Yongin-si (KR)

(72) Inventor: Young Sun KIM, Yongin-si (KR)

(21) Appl. No.: 14/684,788

(22) Filed: Apr. 13, 2015

(30) Foreign Application Priority Data
Aug. 28, 2014 (KR) 10-2014-0113438
Aug. 29, 2014 (KR) 10-2014-0114599
Sep. 3, 2014 (KR) 10-2014-0116930
Oct. 8, 2014 (KR) 10-2014-0135947

(51) Int. Cl. G21D 1/04

(52) U.S. Cl. CPC G21D 1/04

(57) ABSTRACT

Disclosed is a nuclear power generation system that may secure safety even in a case where a failure occurs in a system due to natural disasters or component malfunction.

The nuclear power generation system includes a nuclear reactor, a turbine generator, steam condensers, a water supply pump, and a cooling water pump, in which the water supply pump and the cooling water pump may be steam operated pumps that are operated by steam generated by the nuclear reactor.

### CROSS-REFERENCE TO RELATED APPLICATION(S)

This application claims priority from Korean Patent Application Nos. 10-2014-0113438, filed on Aug. 28, 2014, 10-2014-0114599, filed on Aug. 29, 2014, 10-2014-0116930, filed on Sep. 3, 2014, and 10-2014-0135947, filed on Oct. 8, 2014, in the Korean Intellectual Property Office, the entire disclosures of which are incorporated herein by references for all purposes.

### BACKGROUND

1. Field

The following description relates generally to a nuclear power generation system, and more particularly to a nuclear power generation system that may ensure safety of the system even though the generation system is broken down due to natural disasters, problems in components, and the like.

2. Description of the Related Art

In a nuclear power plant, power generation may generally be stopped due to natural disasters, mistakes of operators, pump malfunction, power line problems, and the like. Under these circumstances, radioactive leak would lead to a huge catastrophe.

For this reason, a nuclear power plant is designed to secure stability through gravity, condensation, boiling, and the like, without using an external power.

In one example, there is a passive secondary condensation system that enhances stability and economic efficiency of a nuclear power plant when an accident occurs in a nuclear reactor, by condensing steam generated at a secondary side of a steam generator and passively cooling residual heat of a reactor. However, the system has a problem in that when low-temperature condensed water cooled by cooling water is introduced through a steam generator, constituent components in the steam generator, which are vulnerable to heat shock, may be affected by heat shock.

Accordingly, a device has been developed for increasing low temperature of condensed water in a passive auxiliary feed water system during an initial operation. Korean Laid-open Patent Publication No. 2014-0032139 discloses a system in a heat exchanging device for preventing heat shock using main steam, which is illustrated in FIG. 1, in which a temperature of condensed water is increased by main steam using a branch pipe from a main steam pipe and a heat exchanging unit 700 installed outside a condensed water collecting pipe, thereby minimizing heat shock that affects a steam generator 100.

However, in the system, cooling water in the passive condensation cooling tank 600 is evaporated during a process of cooling main steam, requiring sufficient amount of cooling water. If all the cooling water is evaporated, no condensed water can be supplied to the steam generator 100, and disaster may occur due to reactor melting.

### SUMMARY

Provided is a nuclear power generation system, in which safety of the system may be ensured even in a case where it is broken down due to natural disasters or component problems.

In one general aspect, there is provided a nuclear power generation system including:

a power generation cycle that includes a nuclear reactor, a turbine generator, a first steam condenser, and a water supply pump; and a cooling water pump configured to supply cooling water to the first steam condenser, in which the water supply pump and the cooling water pump are operated by steam generated by the nuclear reactor, and the steam used to operate the water supply pump and the cooling water pump circulates in such a manner that after passing through a second steam condenser, the steam is introduced into the water supply pump.

In another general aspect, there is provided a nuclear power generation system including: a power generation cycle that includes a nuclear reactor, a turbine generator, a first steam condenser, and a water supply pump; a cooling water pump configured to supply cooling water to the first steam condenser; and an air compressor, in which the water supply pump and the cooling water pump are operated by compressed air generated by the air compressor, the air compressor is operated by steam generated by the nuclear reactor, and the steam used to operate the air compressor circulates in such a manner that after passing through a second steam condenser, the steam is introduced into the water supply pump.

In still another general aspect, there is provided a nuclear power generation system including: a power generation cycle that includes a nuclear reactor, a turbine generator, a first steam condenser, and a water supply pump; a cooling water pump configured to supply cooling water to the first steam condenser; a passive condensation cooling tank that includes a passive condensation heat exchanger configured to collect and condense main steam discharged from the nuclear reactor; a cooling water supply pump configured to supply cooling water to the passive condensation cooling tank; and an air compressor, in which the cooling water supply pump is operated by compressed air generated by the air compressor, the air compressor is operated by steam generated by the nuclear reactor, and the steam used to operate the air compressor circulates in such a manner that after passing through a heat exchanging unit, the steam is introduced into the nuclear reactor.

The air compressor may be a steam turbine air compressor having a turbine and a compression pump that are connected by an axis.

The nuclear power generation system may further include a steam condenser for emergency use that is connected in parallel to the turbine generator, in which the nuclear reactor, the steam condenser for emergency use, the steam condensers, the water supply pump form a closed circuit when a failure occurs in the turbine generator.

The nuclear power generation system may further include an air pump unit that removes impurities and moisture from the compressed air, and stores and distributes the compressed air.

In yet another general aspect, there is provided a nuclear power generation system including: a power generation cycle that includes a nuclear reactor, a turbine generator, a first steam condenser, and a water supply pump; a cooling water pump configured to supply cooling water to the first steam condenser; a passive condensation cooling tank that includes a passive condensation heat exchanger configured to collect and condense main steam discharged from the nuclear reactor; and a cooling water supply pump configured to supply cooling water to the passive condensation cooling tank, in which the cooling water supply pump is operated by steam generated by the nuclear reactor, and the steam used to operate the cooling water supply pump circulates in such a manner that after passing through a heat exchanging unit, the steam is introduced into the nuclear reactor.

In yet another general aspect, there is provided a nuclear power generation system including: a distributed power generation cycle that includes a turbine generator, a steam condenser, and a water supply pump; a heat shock preventing cycle that includes a steam condenser and a water supply pump; and a power supply cycle that includes a steam turbine air compressor, a steam condenser, and a water supply pump, in which the distributed power generation cycle, the heat shock preventing cycle, and the power supply cycle are connected in parallel to form a closed circuit with the nuclear reactor.

### BRIEF DESCRIPTION OF THE DRAWINGS

FIG. 1 is a diagram illustrating an example of a nuclear power generation system to which a conventional passive feedwater system is applied.

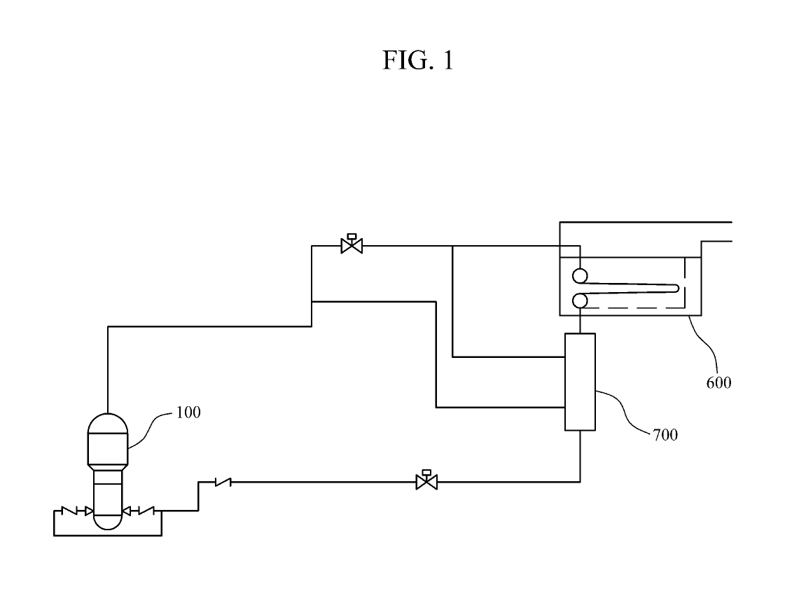

FIG. 2 is a diagram illustrating an example of a nuclear power generation system according to an exemplary embodiment.

FIG. 3 is a diagram illustrating a fluid flow of the nuclear power generation system in FIG. 2 that is operated under abnormal conditions due to a problem in the system.

FIG. 4 is a diagram illustrating an example of a nuclear power generation system according to another exemplary embodiment.

FIG. 5 is a diagram illustrating a fluid flow of the nuclear power generation system in FIG. 4 that is operated under abnormal conditions due to a problem in the system.

FIG. 6 is a diagram illustrating an example of a nuclear power generation system according to still another exemplary embodiment.

FIG. 7 is a diagram illustrating an example of a nuclear power generation system according to yet another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

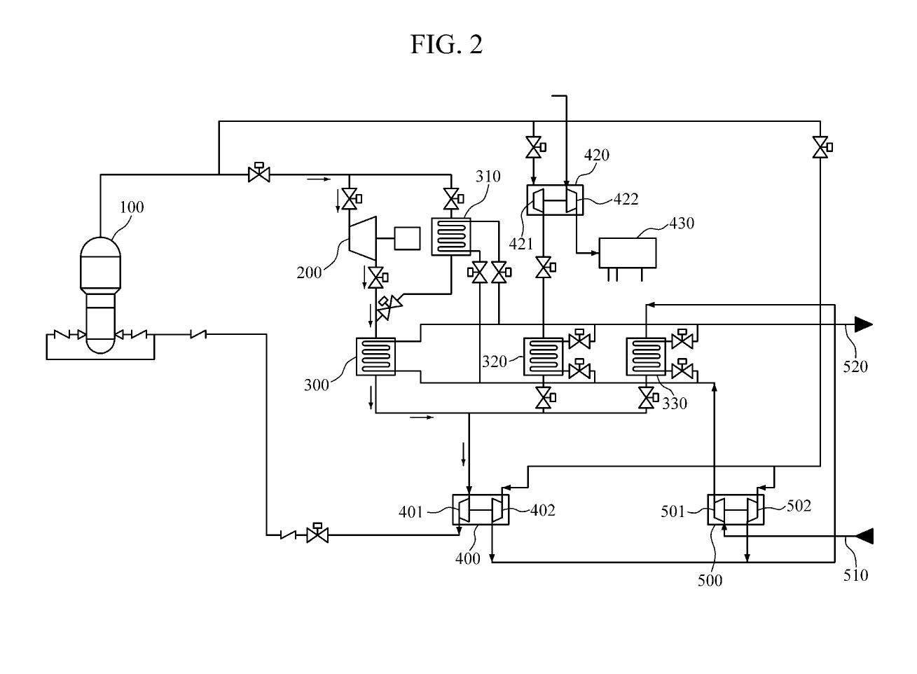

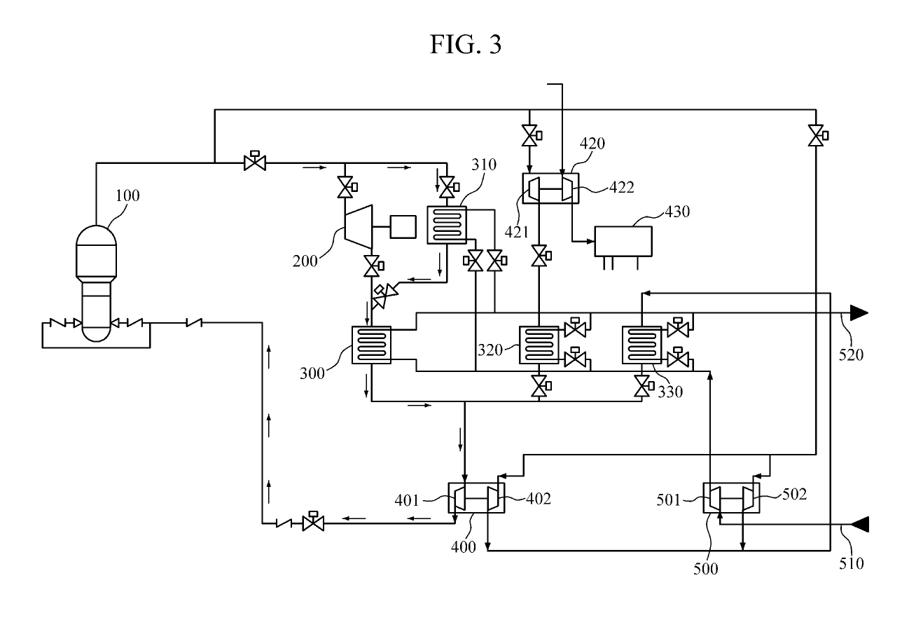

FIG. 2 is a diagram illustrating an example of a nuclear power generation system according to an exemplary embodiment. FIG. 3 is a diagram illustrating a fluid flow of the nuclear power generation system in FIG. 2 that is operated under abnormal conditions due to a problem in the system.

Referring to FIGS. 2 and 3, the nuclear power generation system includes a steam generator 100, a turbine generator 200, steam condensers 300, 320, and 330, water supply pump 400, a cooling water pump 500, and a steam condenser 310 for emergency use. The water supply pump 400 and the cooling water pump 500 may be a steam operated pump that is operated using steam generated by the steam generator 100.

The nuclear power generation system in FIGS. 2 and 3 is of a pressurized light water reactor type. However, the system may be applied to a Boiling Water Reactor (BWR) type. In a case where the system is applied to a nuclear power generation system of the BWR type, steam is generated not in the steam generator 100 but in a reactor. Accordingly, in the nuclear power system of the BWR type, a nuclear reactor may be disposed instead of the steam generator 100.

The water supply pump 400 may have a turbine 401 and a pump 402 that are connected by an axis. Further, the cooling water pump 500 may have a turbine 501 and a pump 502 that are connected by an axis. The cooling water pump 500 uses steam generated by the steam generator 100 as power sources to enable cooling water to be absorbed through a cooling water inlet 510 to pass through the steam condensers 300, 320, and 330, and to be discharged through a cooling water outlet 520. In this process, steam in the steam condensers 300, 320, and 330 may be condensed to be condensed water, and may be supplied to the steam generator 100.

The steam condenser 310 for emergency use may be connected in parallel to the turbine generator 200. The steam condenser 310 for emergency use may be identical to a general steam condenser. By using the steam condenser 310 for emergency use, the steam generator 100, the steam condenser 310 for emergency use 310, the steam condenser 300, and the water supply pump 400 may form a closed circuit when a failure occurs in the turbine generator 200, so that heat shock on the steam generator may be prevented, and safety of the system may be secured.

As described above, the nuclear power generation system operates the water supply pump 400 and the cooling water pump 500 by using steam generated by the steam generator, so as to ensure a stable power generation even in a case where a failure occurs in an electric system. Further, the system is economical as there is no need for additional power to operate the water supply pump 400 and the cooling water pump 500.

Further, steam used to operate the water supply pump 400 and the cooling water pump 500 circulates in such a manner that after passing through the steam condenser 330, the steam is introduced into the water supply pump 400. In this manner, as the steam is not discharged to the outside but circulates inside the system, there is no concern that the steam contaminated by radioactivity will be discharged to the outside, thereby improving stability.

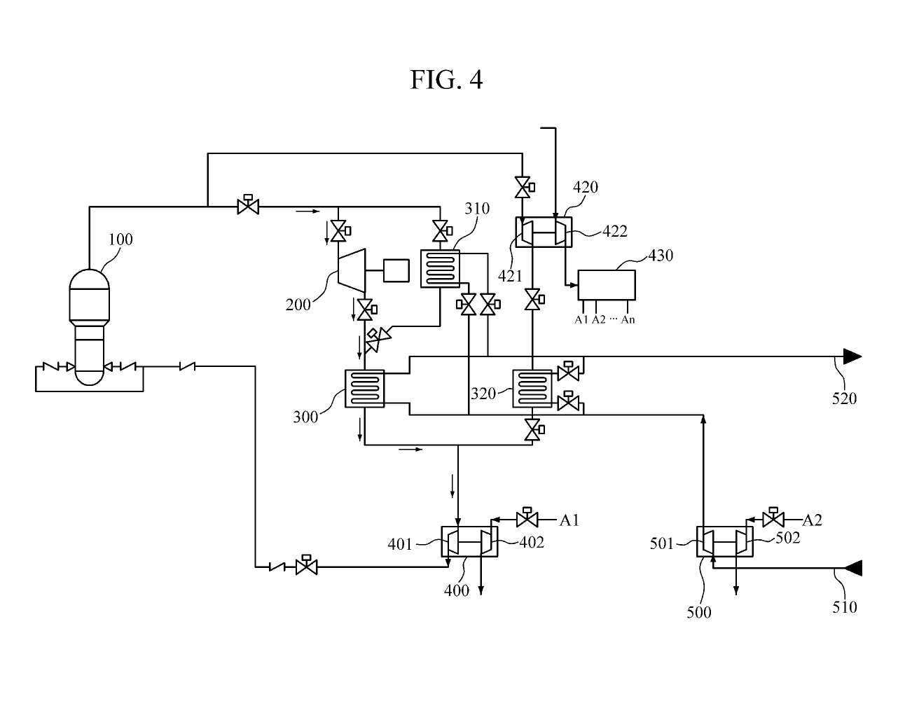

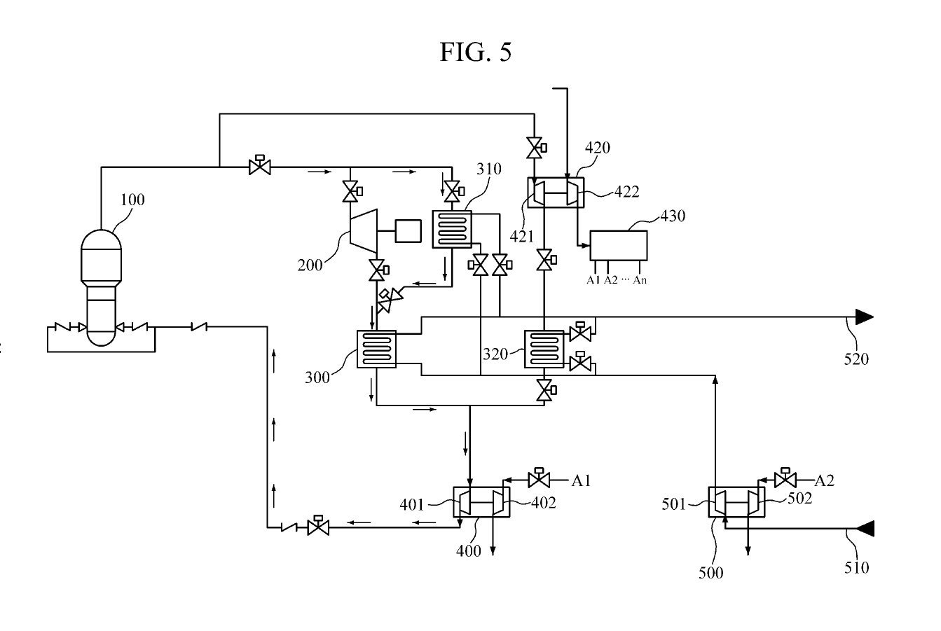

FIG. 4 is a diagram illustrating an example of a nuclear power generation system according to another exemplary embodiment. FIG. 5 is a diagram illustrating a fluid flow of the nuclear power generation system in FIG. 4 that is operated under abnormal conditions due to a problem in the system.

As illustrated in FIGS. 4 and 5, the nuclear power generation system includes a steam generator 100, a turbine generator 200, steam condensers 300 and 320, water supply pump 400, a cooling water pump 500, air compressor 420, and a steam condenser 310 for emergency use. The water supply pump 400 and the cooling water pump 500 may be operated by condensed air generated by the air compressor 420. The air compressor 420 may be operated by steam generated by the steam generator 100. The air compressor 420 may be a steam turbine air compressor having a turbine 421 and a compression pump 422 that are connected by an axis.

The nuclear power generation system illustrated in FIGS. 4 and 5 is of a pressurized light water reactor type. However, the system may be applied to a Boiling Water Reactor (BWR) type. In a case where the system is applied to a nuclear power generation system of the BWR type, steam is not generated in the steam generator 100 but in a reactor. Accordingly, in the nuclear power system of the BWR type, a nuclear reactor may be disposed instead of the steam generator 100.

The water supply pump 400 may have a turbine 401 and a pump 402 that are connected by an axis. Further, the cooling water pump 500 may have a turbine 501 and a pump 502 that are connected by an axis. The cooling water pump 500 uses compressed air generated by the air compressor 420 as power sources to enable cooling water to be absorbed through a cooling water inlet 510 to pass through the steam condensers 300 and 320, and to be discharged through a cooling water outlet 520. In this process, steam in the steam condensers 300 and 320 may be condensed to be condensed water, and may be supplied to the steam generator 100,

The steam condenser 310 for emergency use may be connected in parallel to the turbine generator 200. The steam condenser 310 for emergency use may be identical to a general steam condenser. By using the steam condenser 310 for emergency use, the steam generator 100, the steam condenser 310 for emergency use 310, the steam condenser 300, and the water supply pump 400 may form a closed circuit when a failure occurs in the turbine generator 200, so that heat shock on the steam generator may be prevented, and safety of the system may be secured.

As described above, in the nuclear power generation system, the air compressor 420 is operated using steam generated by the steam generator 100, and the water supply pump 400 and the cooling water pump 500 are operated by compressed air generated by the air compressor 420, thereby enabling a stable power generation even in a case where a failure occurs in an electric system. Further, the system is economical as there is no need for additional power to operate the water supply pump 400 and the cooling water pump 500.

Further, steam used to operate the air compressor 420 circulates in such a manner that after passing through the steam condenser 320, the steam is introduced into the water supply pump 400. In this manner, as the steam is not discharged to the outside but circulates inside the system, there is no concern that the steam contaminated by radioactivity will be discharged to the outside, thereby improving stability.

The nuclear power generation system may further include an air pump unit 430. The air pump unit 430 stores and distributes compressed air, and removes impurities and moisture from compressed air, thereby preventing system performance degradation caused by such impurities and moisture contained in compressed air.

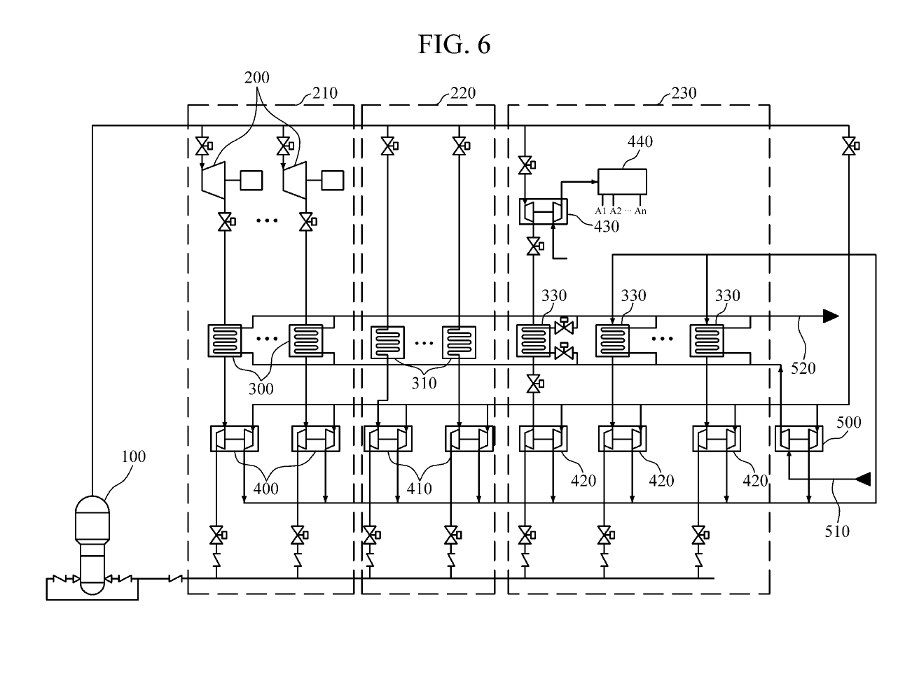

FIG. 6 is a diagram illustrating an example of a nuclear power generation system according to still another exemplary embodiment.

Referring to FIG. 6, the nuclear power generation system includes a distributed power generation cycle 210, a heat shock preventing cycle 220, and a power supply cycle 230. The distributed power generation cycle 210 includes a turbine generator 200, a steam condenser 300, a water supply pump 400. The heat shock preventing cycle 220 includes a steam condenser 310, a water supply pump 410. The power supply cycle 230 includes a steam turbine air compressor 440, a steam condenser 330, a water supply pump 500. Further, in the nuclear power generation system, the distributed power generation cycle 210, the heat shock preventing cycle 220, and the power supply cycle 230 may be connected in parallel to form a closed circuit with the steam generator 100.

The nuclear power generation system illustrated in FIG. 6 is of a pressurized light water reactor type. However, the system may be applied to a Boiling Water Reactor (BWR) type. In a case where the system is applied to a nuclear power generation system of the BWR type, steam is not generated in the steam generator 100 but in a reactor. Accordingly, in the nuclear power system of the BWR type, a nuclear reactor may be disposed instead of the steam generator 100.

The water supply pump 400 and the cooling water pump 500 may be a steam operated pump, in which a turbine and a pump are connected by an axis. By using a water supply pump as a steam operated pump, cooling water may be supplied to the steam generator 100 by only using steam generated by the steam generator even in a case where a failure occurs in an electric system, thereby securing safety of the system.

As described above, in the nuclear power generation system, small steam turbine generators, instead of big ones, are connected in parallel, such that stable power generation may be secured even in a case where there is a problem in some constituent components of a power generation cycle.

Further, steam used to operate the air compressor 950 circulates in such a manner that after passing through the heat exchanging unit 700, the steam is introduced into the steam generator 100. In this manner, as the steam is not discharged to the outside but circulates inside the system, there is no concern that the steam contaminated by radioactivity will be discharged to the outside, thereby improving stability.

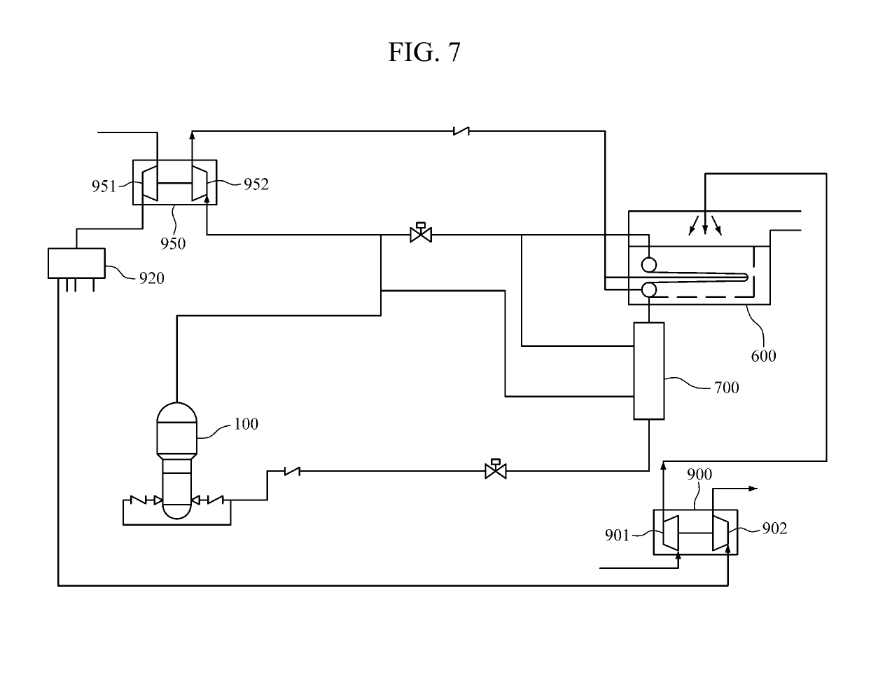

FIG. 7 is a diagram illustrating an example of a nuclear power generation system according to yet another exemplary embodiment.

Referring to FIG. 7, the nuclear power generation system includes a steam generator 100, a turbine generator (not shown), a steam condenser (not shown), a water supply pump (not shown), a cooling water pump (not shown), a passive condensation cooling tank 600, a cooling water supply pump 900, and an air compressor 950.

The passive condensation cooling tank 600 includes passive condensation heat exchanger that collects and condenses main steam discharged from the steam generator 100. A condensed water collecting pipe collects water condensed in the passive condensation cooling tank and supplies the condensed water to the steam generator 100.

The cooling water supply pump 900 is operated by condensed air to supply cooling water to the passive condensation cooling tank 600. The cooling water supply pump 900 may have a turbine 901 and a pump 902 that are connected by an axis.

The air compressor 950 may be a steam turbine air compressor having a turbine 951 and a compression pump 952 that are connected by an axis. The air compressor 950 absorbs air and sends it out.

As described above, the nuclear power generation system provides the steam generator 100 with condensed water obtained by condensing main steam discharged from the steam generator 100. An air operated pump is used to supply cooling water to the passive condensation cooling tank 600 for condensing main steam. The air operated pump supplies cooling water by absorbing cooling water through a cooling water inlet and discharging the cooling water through a cooling water supply pipe.

By using the air operated pump to supply cooling water, cooling water may be provided continuously to the passive condensation cooling tank 600 by operating the air operated pump with compressed air even in a case where electric power may not be supplied due to a failure in an electric system of the nuclear power generation system.

Accordingly, the volume of the passive condensation cooling tank 600 may be designed to be small, which provides economic efficiency. Further, cooling water may be supplied constantly even without electric power supply, thereby securing safety of the system.

The nuclear power generation system illustrated in FIG. 7 is of a pressurized light water reactor type. However, the system may be applied to a Boiling Water Reactor (BWR) type. In a case where the system is applied to a nuclear power generation system of the BWR type, steam is not generated in the steam generator 100 but in a reactor. Accordingly, in the nuclear power system of the BWR type, a nuclear reactor may be disposed instead of the steam generator 100.

Further, the nuclear power generation system may further include an air pump unit 920. The air pump unit 920 stores and distributes compressed air, and removes impurities and moisture from compressed air, thereby preventing system performance degradation caused by such impurities and moisture contained in compressed air.

As described above, when a failure occurs in the nuclear power generation system, sufficient time for taking actions may be secured. Further, safety and economic efficiency of the nuclear power generation system may also be guaranteed.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A nuclear power generation system comprising:
a power generation cycle that comprises a nuclear reactor, a turbine generator, a first steam condenser, and a water supply pump; and
a cooling water pump configured to supply cooling water to the first steam condenser,
wherein the water supply pump and the cooling water pump are operated by steam generated by the nuclear reactor, and the steam used to operate the water supply pump and the cooling water pump circulates in such a manner that after passing through a second steam condenser, the steam is introduced into the water supply pump.

2. The system of claim 1, further comprising a steam condenser for emergency use,
wherein when a failure occurs in the turbine generator, the nuclear reactor, the steam condenser for emergency use, the first steam condenser, and the water supply pump form an emergency cycle.

3. A nuclear power generation system comprising:
a power generation cycle that comprises a nuclear reactor, a turbine generator, a first steam condenser, and a water supply pump;
a cooling water pump configured to supply cooling water to the first steam condenser; and
an air compressor,
wherein the water supply pump and the cooling water pump are operated by compressed air generated by the air compressor, the air compressor is operated by steam generated by the nuclear reactor, and the steam used to operate the air compressor circulates in such a manner that after passing through a second steam condenser, the steam is introduced into the water supply pump.

4. The system of claim 3, further comprising an air pump unit that removes impurities and moisture from the compressed air, and stores and distributes the compressed air.

5. The system of claim 3, further comprising a steam condenser for emergency use, wherein when a failure occurs in the turbine generator, the nuclear reactor, the steam condenser for emergency use, the first steam condenser, and the water supply pump form an emergency cycle.

6. A nuclear power generation system comprising:
a power generation cycle that comprises a nuclear reactor, a turbine generator, a first steam condenser, and a water supply pump;
a cooling water pump configured to supply cooling water to the first steam condenser;
a passive condensation cooling tank that comprises a passive condensation heat exchanger configured to collect and condense main steam discharged from the nuclear reactor;
a cooling water supply pump configured to supply cooling water to the passive condensation cooling tank; and
an air compressor,
wherein the cooling water supply pump is operated by compressed air generated by the air compressor, the air compressor is operated by steam generated by the nuclear reactor, and the steam used to operate the air compressor circulates in such a manner that after passing through a heat exchanging unit, the steam is introduced into the nuclear reactor.

7. A nuclear power generation system comprising:
s a power generation cycle that comprises a nuclear reactor, a turbine generator, a first steam condenser, and a water supply pump;
a cooling water pump configured to supply cooling water to the first steam condenser;
a passive condensation cooling tank that comprises a passive condensation heat exchanger configured to collect and condense main steam discharged from the nuclear reactor; and
a cooling water supply pump configured to supply cooling water to the passive condensation cooling tank,
wherein the cooling water supply pump is operated by steam generated by the nuclear reactor, and the steam used to operate the cooling water supply pump circulates in such a manner that after passing through a heat exchanging unit, the steam is introduced into the nuclear reactor.

8. A nuclear power generation system comprising:
a distributed power generation cycle that comprises a turbine generator, a steam condenser, and a water supply pump;
a heat shock preventing cycle that comprises a steam condenser and a water supply pump; and
a power supply cycle that comprises a steam turbine air compressor, a steam condenser, and a water supply pump,
wherein the distributed power generation cycle, the heat shock preventing cycle, and the power supply cycle are connected in parallel to form a closed circuit with the nuclear reactor.
